(19) United States
(12) Patent Application Publication
(10) Pub. No.: US 2006/0151269 A1
(43) Pub. Date: Jul. 13, 2006

(54) Cylinder cushion device

(75) Inventors: Toshimichi Ikeda, Changwon (KR); Yang Koo Lee, Changwon (KR)

Correspondence Address: LADAS & PARRY, 26 WEST 61ST STREET, NEW YORK, NY, 10023, US

(73) Assignee: VOLVO CONSTRUCTION EQUIPMENT HOLDING SWEDEN AB

(21) Appl. No.: 11/073,390

(22) Filed: Mar. 4, 2005

(30) Foreign Application Priority Data
Jan. 3, 2005 (KR) 10-2005-0000119

(51) Int. Cl. F16F 15/03

(52) U.S. Cl. 188/267; 188/322.16; 267/119

(57) ABSTRACT

A cylinder cushion device is provided for a hydraulic cylinder of an excavator, to prevent a piston from colliding with an end boss and absorb shock due to collision. Pressure higher than design strength of the hydraulic cylinder does not occur even if external force is given to the hydraulic cylinder. The cylinder cushion device includes a tube constituting a receiving chamber of hydraulic oil, a rod performing straight line motion, a piston fixed onto the rod and dividing the receiving chamber of the tube, an end boss, a cushion sleeve provided on the rod to be adjacent to the piston, for generating a predetermined cushion pressure inside the rod-side chamber if the piston is adjacent to the end boss during straight line motion of the rod, and an elastic body provided on the cushion sleeve for preventing the piston from colliding with the end boss and absorbing shock by means of its elasticity.

### CROSS-REFERENCE TO RELATED APPLICATIONS

This application claims benefit under 35 U.S.C. § 119 from Korean Patent Application No. 2005-119, filed on Jan. 3, 2005, the entire content of which is incorporated herein by reference.

### BACKGROUND OF THE INVENTION

1. Field of the Invention

The present invention relates to a cylinder cushion device, and more particularly to, a cylinder cushion device which is provided inside a hydraulic cylinder of an excavator driven by a hydraulic driving apparatus using an engine as motive power, to prevent a piston from colliding with an end boss.

2. Description of the Related Art

Generally, an excavator is a type of a construction equipment used to excavate the ground or shovel earth and sand in the construction site. As shown in FIG. 1 and FIG. 2, an excavator 1 includes a lower traveling structure 10 of a crawler or wheel type, an upper swing structure 20 swing on the lower traveling structure 10 by means of a swing gear 21, and a working device 30 provided on the upper swing structure 20.

The upper swing structure 20 is provided with a hydraulic driving apparatus and a driver's seat 28. The hydraulic driving apparatus is provided to drive the working device 30 and includes an engine 22, a pump 23, a hydraulic tank 24, a control valve 25, a radiator 26, and an oil cooler 27. The working device 30 includes a boom 32 driven by an actuator 31, an arm 34 driven by an actuator 33, and a bucket 36 driven by an actuator 35.

The driving principle of the actuators 31, 33, and 35 of the working device 30 will now be described with reference to FIG. 2.

First, once the pump 23 is driven by the engine 22, hydraulic oil inside the hydraulic tank 24 is discharged through a pipe 29a. The discharged hydraulic oil is moved to the control valve 25 and then to the actuators 31, 33, and 35 of the working device 30 under the control of the control valve 25 to drive the boom 32, the arm 34 and the bucket 36.

Once the boom 32, the arm 34, and the bucket 36 are driven, the hydraulic oil is discharged from the control valve 25 at high temperature and then is cooled by the oil cooler 27. The hydraulic oil cooled by the oil cooler 27 returns to the hydraulic tank 24 through a pipe 29b.

The aforementioned actuators 31, 33, and 35 are provided in a type of a hydraulic cylinder 40. FIGS. 3A and 3B illustrate a cushion device formed in the hydraulic cylinder 40, and FIG. 4 illustrates a diagram of pressure proceeding at rod-side chamber (A) and bottom-side chamber (B) in the hydraulic cylinder by the cylinder cushion device.

As shown in FIGS. 3A and 3B, the hydraulic cylinder 40 constituting the actuators 31, 33, and 35 includes a tube 41 constituting a receiving chamber of the hydraulic oil, a rod 42 operating the boom 32, the arm 34, or the bucket 36 while performing straight line motion inside the tube 41 depending on inflow/outflow of the hydraulic oil, a piston 43 fixed onto the rod 42, and an end boss 44 provided at the end of the tube 41. A seal 45 is fixed to the piston 43 and serves to separate a rod-side chamber A from a bottom-side chamber B and block motion of the hydraulic oil between the chambers.

A cushion device 46 is provided in the rod-side chamber 4 to prevent the piston 43 from colliding with the end boss 44. To this end, the cushion sleeve 46 is provided at the front of the piston 43, and a hole 47 is formed in the end boss 44 so that the cushion sleeve 46 is inserted thereto with a predetermined clearance C.

Therefore, if the hydraulic oil flows from the control valve 25 to the bottom-side chamber B to drive the actuators 31, 33, and 35, the piston 43 is moved to the rod-side by bottom-side pressure Pb formed in the bottom-side chamber B. If the cushion sleeve 46 is inserted into the hole 47 of the end boss 44, the hydraulic oil inside the rod-side chamber A is maintained as it is except a small amount ejected to an outlet 48 through the clearance C. In this case, relatively high pressure occurs in the rod-side chamber A. This pressure acts as a cushion pressure Pc against motion of the piston 43, so that the piston 43 is prevented from colliding with the end of the end boss 44.

For an actual experiment example, the pressure inside the rod-side chamber A when the cushion sleeve 46 is inserted into the hole 47 corresponds to 431 kg/cm². Parts of the hydraulic cylinder 40, such as the tube 41 and the end boss 44, are designed to bear such pressure.

However, high pressure occurs in the rod-side chamber A if the bucket 36 is manipulated toward ‘Out’ direction (see FIG. 1) at the time when the piston 43 of the actuator 33 approaches to the end boss 44 and the pressure in the rod-side chamber A acts as the cushion pressure Pc against motion of the piston 43.

The cushion pressure Pc is generally determined by the clearance C but maximum pressure under the normal condition is determined by a value obtained by converting the bottom-side pressure Pb into bottom-side area Ab to rod-side area Ar ratio Ab/Ar.

However, if the bucket 36 is manipulated toward the ‘Out’ direction to move rock, a repulsive force toward ‘In’ direction occurs. This repulsive force corresponds to half of an excavating force toward a general ‘In’ direction of the bucket 36 but is relatively great. The repulsive force is enhanced by level-to-level ratio L2/L1 of the arm 34 and is given to the rod 42 to enhance the pressure inside the rod-side chamber A. Accordingly, the whole pressure inside the rod-side chamber A consists of sum of the cushion pressure Pc and the rod pressure Pa generated by a force from the rod 42, and substantially reaches 1000 kg/cm² to 1000 kg/cm² higher than design strength. Expansion occurs between the tube 41 and the end boss 44 as shown in FIG. 4 due to the above pressure. The seal 45 is detached from the space between the tube 41 having an increased inner diameter and the piston 43 without overcoming the pressure. For this reason, a problem occurs in that the hydraulic cylinder 40 is damaged.

To solve such a problem, the clearance C may be provided in a greater size so as not to increase the pressure inside the rod-side chamber A. However, in this case, the cushion function against the piston 43 does not work. This could lead to collision between the piston 43 and the end boss 44. Shock due to such collision may cause a driver of the excavator inconvenience as well as damage of various parts.

### SUMMARY OF THE INVENTION

Accordingly, the present invention is directed to a cylinder cushion device that substantially obviates one or more problems due to limitations and disadvantages of the related art.

An object of the present invention is to provide a cylinder cushion device that prevents a piston from colliding with an end boss and absorbs shock due to collision.

Another object of the present invention is to provide a cylinder cushion device in which pressure higher than design strength of a hydraulic cylinder does not occur in a rod-side chamber or a bottom-side chamber even if external force is given to the hydraulic cylinder through a rod.

To achieve these objects and other advantages and in accordance with the purpose of the invention, as embodied and broadly described herein, a cylinder cushion device placed in a hydraulic cylinder of an excavator, the hydraulic cylinder including a tube constituting a receiving chamber of hydraulic oil, a rod performing straight line motion inside the tube depending on inflow and outflow of the hydraulic oil, a piston fixed onto the rod, dividing the receiving chamber of the tube into a rod-side chamber and a bottom-side chamber, and an end boss placed at one end of the tube, having holes that enable insertion of the rod and outflow of the hydraulic oil, the cylinder cushion device includes a cushion sleeve provided on the rod to be adjacent to the piston, generating a predetermined cushion pressure inside the rod-side chamber as it is inserted into the hole of the end boss with a predetermined clearance if the piston is adjacent to the end boss during straight line motion of the rod, and an elastic body provided on the cushion sleeve, preventing the piston from colliding with the end boss and absorbing shock by means of its elasticity.

Preferably, the cushion sleeve has a small length to smoothly eject the hydraulic oil inside the rod-side chamber, thereby preventing the cushion pressure inside the rod-side chamber from excessively increasing.

Preferably, the cushion sleeve has a small outer diameter to smoothly eject the hydraulic oil inside the rod-side chamber, thereby preventing the cushion pressure inside the rod-side chamber from excessively increasing.

Preferably, the elastic body has an O-ring shape of rubber material with a round shaped cross-section.

Preferably, the elastic body has an O-ring shape of rubber material with a polygonal cross-section.

Preferably, the elastic body has a ring shape of composite material with metal plates formed on both (i.e., opposite) sides of a central elastic material.

### BRIEF DESCRIPTION OF THE DRAWINGS

The above aspects and features of the present invention will be more apparent by describing certain embodiments of the present invention with reference to the accompanying drawings, in which:

FIG. 1 illustrates a general excavator;

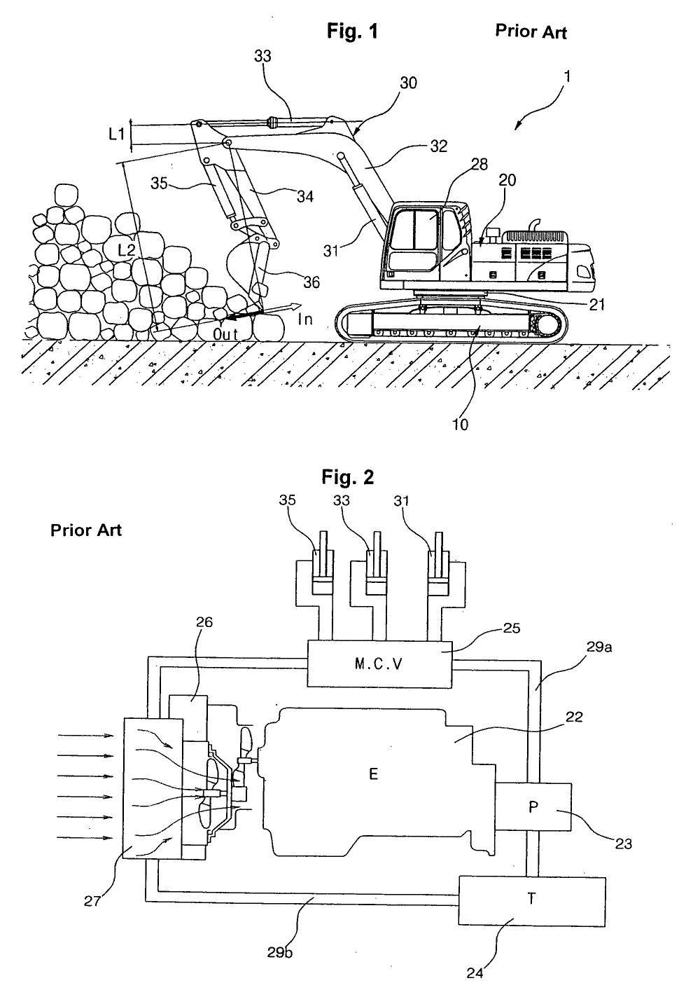

FIG. 2 illustrates a driving principle of an operational equipment in a general excavator;

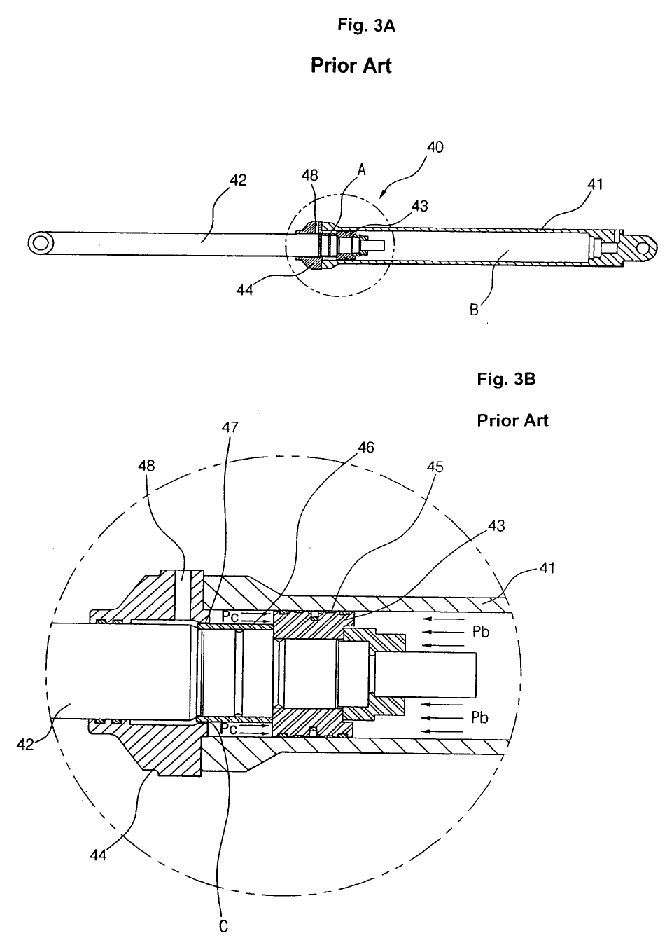

FIGS. 3A and 3B illustrate a related art cylinder cushion device;

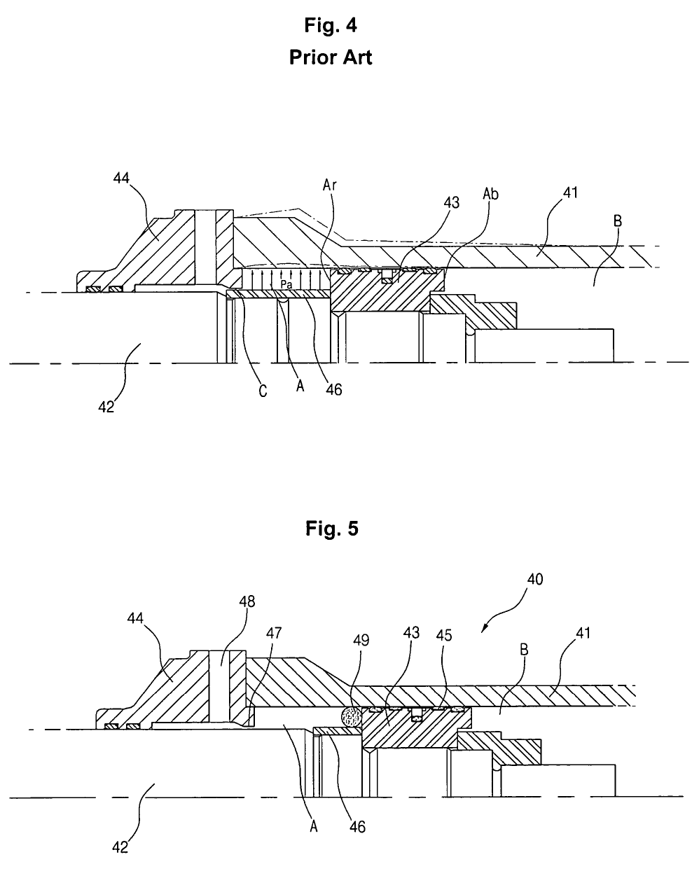

FIG. 4 illustrates the damage state of a hydraulic cylinder due to rod-side pressure in a hydraulic cylinder provided with a related art cylinder cushion device;

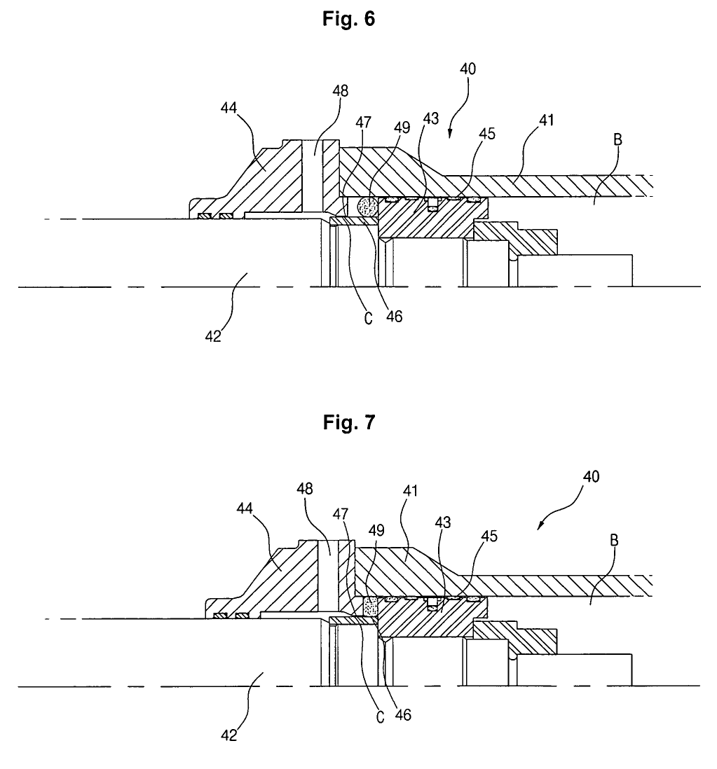

FIG. 5 to FIG. 7 illustrate structure and operation of a cylinder cushion device according to the first embodiment of the present invention provided inside a rod-side chamber;

FIG. 8 illustrates a cushion sleeve in a cylinder cushion device according to the first embodiment of the present invention provided inside a rod-side chamber;

FIG. 9 and FIG. 10 illustrate structure and operation of a cylinder cushion device according to the second embodiment of the present invention provided inside a rod-side chamber; and

FIGS. 11A, 11B and 12 illustrate structure and operation of a cylinder cushion device according to the second embodiment of the present invention provided inside a bottom-side chamber.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

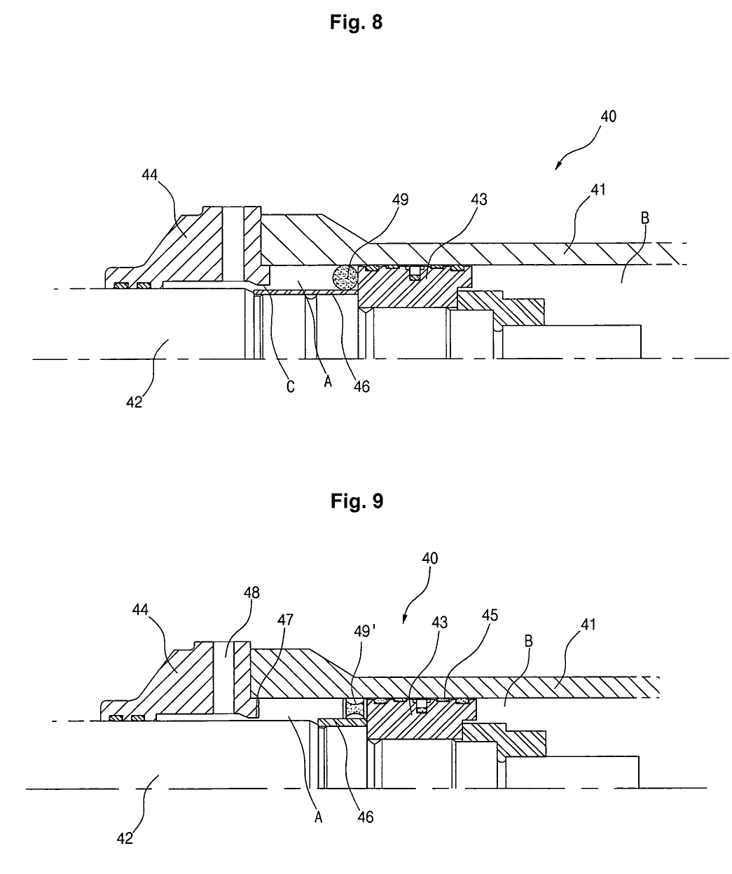

As shown in FIG. 5 to FIG. 12, a cylinder cushion device of the present invention is provided in a hydraulic cylinder 40 of an excavator 1. The hydraulic cylinder 40 includes a tube 41 constituting a receiving chamber of hydraulic oil, provided with an inlet (not shown) and outlets 48 and 48′ of the hydraulic oil at both sides, a rod 42 operating a boom 33, an arm 34, or a bucket 36 while performing straight line motion inside the tube 41 depending on inflow and outflow of the hydraulic oil, a piston 43 fixed onto the rod 42, rod-side and bottom-side end bosses 44 and 44′ respectively provided at both ends of the tube 41, each having holes 47 and 47′ that enable insertion of the rod 42 and outflow of the hydraulic oil, and a seal 45 dividing the receiving chamber of the tube 41 into a rod-side chamber A and a bottom-side chamber B.

The cylinder cushion device according to the first embodiment of the present invention, as shown in FIG. 5 to FIG. 7, includes a cushion sleeve 46 and an elastic body 49. The cushion sleeve 46 is provided on the rod 42 to be adjacent to the piston 43 and generates a predetermined cushion pressure inside the rod-side chamber A as it is inserted into the hole 47 of the rod-side end boss 44 with a predetermined clearance C if the piston 43 approaches to the rod-side end boss 44 during straight line motion of the rod 42. The elastic body 49 is provided on the cushion sleeve 46 to prevent the piston from colliding with the rod-side end boss 44 and absorb shock by means of its elasticity.

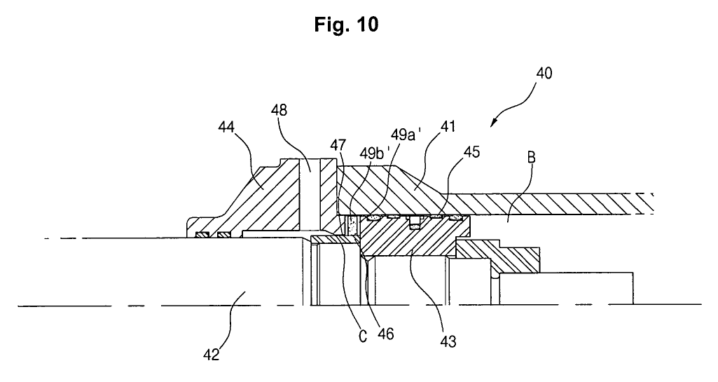

The aforementioned cushion sleeve 46 may be provided to generate proper cushion pressure in the rod-side chamber A if it is inserted into the hole 47 of the rod-side end boss 44 in the same manner as the related art cushion sleeve. Preferably, the cushion sleeve 46 has a length smaller than that of the related art one as shown in FIG. 5 to FIG. 7, or has an outer diameter smaller than that of the related art one as shown in FIG. 8.

If the cushion sleeve 46 has a smaller length as above, insertion time of the cushion sleeve 46 to the hole 47 of the rod-side end boss 44 is delayed and the hydraulic oil inside the rod-side chamber A is smoothly ejected through the greater clearance C. In this case, the cushion pressure inside the rod-side chamber A does not excessively increase so that damage of the hydraulic cylinder 40 due to the whole pressure inside the rod-side chamber A is avoided even if additional rod pressure due to operation of the excavator 1 is given in a state that the piston 43 is adjacent to the rod-side end boss 44.

Furthermore, if the cushion sleeve 46 has a smaller outer diameter as above, the clearance C between the cushion sleeve 46 and the hole 47 becomes greater when the cushion sleeve 46 is inserted into the hole 47 of the rod-side end boss 44. In this case, the hydraulic oil inside the rod-side chamber A is smoothly ejected through the greater clearance C. Therefore, the cushion pressure inside the rod-side chamber A does not excessively increase so that damage of the hydraulic cylinder 40 due to the whole pressure inside the rod-side chamber A is avoided even if additional rod pressure due to operation of the excavator 1 is given in a state that the piston 43 is adjacent to the rod-side end boss 44.

The elastic body 49 provided on the cushion sleeve 46, as shown in FIG. 7, prevents the piston 43 of metal from colliding with the rod-side end boss 44 of metal by being interposed between the piston 43 and the rod-side end boss 44 and at the same time absorbs shock by means of its elasticity if the piston 43 approaches to the rod-side end boss 44.

Preferably, the elastic body 49 is formed of rubber material and has an O-ring shape with a round shaped cross-section. However, the elastic body 49 is not limited to the round shaped cross-section. For example, the elastic body 49 may have an O-ring shape with an optional cross-section such as a polygonal cross-section. Hardness of the elastic body 49 is properly selected considering its function and durability.

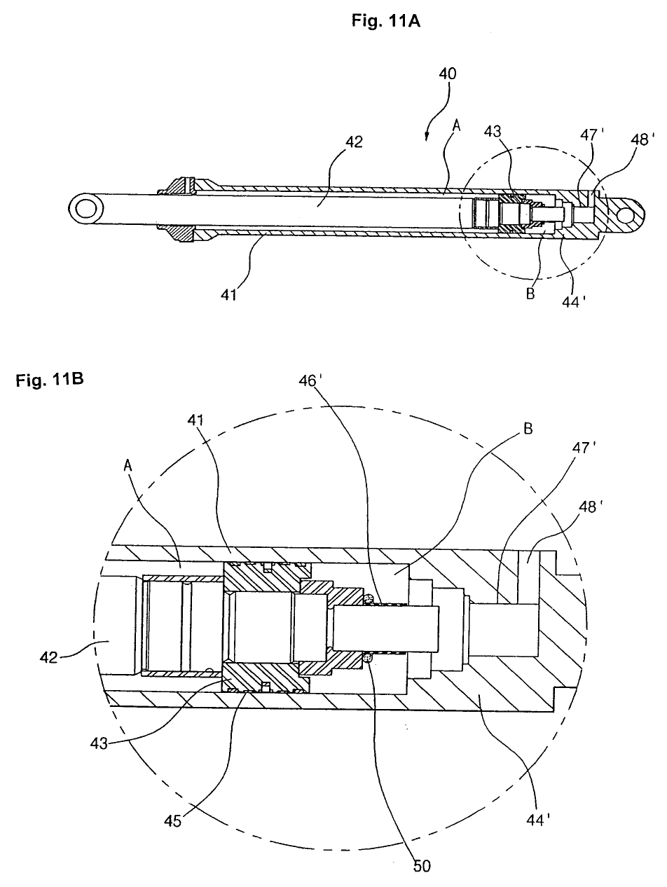

As shown in FIG. 9 and FIG. 10, the cylinder cushion device according to the second embodiment of the present invention is different from that of the first embodiment in that the rod-side cushion sleeve 46 is provided with an elastic body 49′ of a composite material formed with both metal plates 49a′ and a central elastic material 49b′ in a single body instead of the O-ring elastic body 49 of rubber material. Since the other structure and operation of the cylinder cushion device according to the second embodiment are equal to those of the first embodiment, its detailed description will be omitted.

The elastic body 49′, as shown in FIG. 10, prevents the piston 43 of metal from colliding with the rod-side end boss 44 of metal by being interposed between the piston 43 and the rod-side end boss 44 and at the same time absorbs shock by means of elasticity of the central elastic material 49b′ if the piston 43 approaches to the rod-side end boss 44.

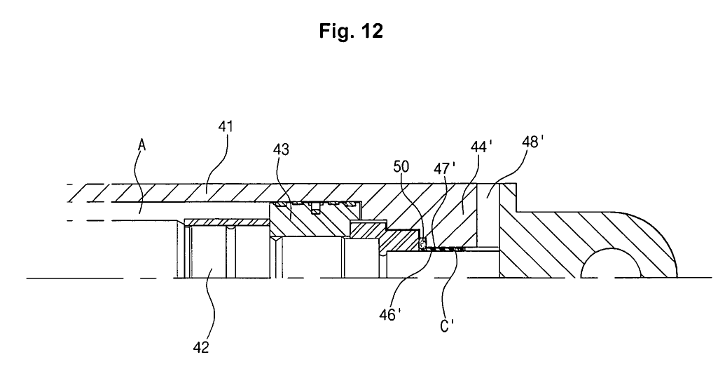

The cylinder cushion device of the present invention may be provided in the bottom-side chamber B in addition to the rod-side chamber A, as shown in FIGS. 11A, 11B and FIG. 12.

In other words, the cylinder cushion device 1′ according to the second embodiment of the present invention includes a cushion sleeve 46′ and an elastic body 50. The cushion sleeve 46′ is provided on the rod 42 to be adjacent to the piston 43 and generates a predetermined cushion pressure inside the bottom-side chamber B as it is inserted into the hole 47′ of the bottom-side end boss 44′ with a predetermined clearance C′ during straight line motion of the rod 42 if the piston 43 is adjacent to the bottom-side end boss 44′. The elastic body 50 is provided on the cushion sleeve 46′ to prevent the piston 43 from colliding with the bottom-side end boss 44′ and absorbs shock by means of its elasticity.

The aforementioned cushion sleeve 46′ has a length or an outer diameter smaller than that of the related art one. In this case, the hydraulic oil inside the bottom-side chamber B is smoothly ejected through the greater clearance C′. Therefore, the cushion pressure inside the bottom-side chamber B does not excessively increase so that damage of the hydraulic cylinder 40 due to the whole pressure inside the bottom-side chamber B is avoided even if additional rod pressure due to operation of the excavator 1 is given in a state that the piston 43 is adjacent to the bottom-side end boss 44′.

Preferably, the elastic body 50 provided on the cushion sleeve 46′ is formed of rubber material and has an O-ring shape with a round shaped cross-section. However, the elastic body 50 is not limited to the round shaped cross-section. For example, the elastic body 50 may have an O-ring shape with an optional cross-section such as a polygonal cross-section. Alternatively, the elastic body 50 may have a ring shape of a composite material with both metal plates formed in a single body with a central elastic material.

The aforementioned elastic body 50, as shown in FIG. 12, prevents the piston 43 of metal from colliding with the bottom-side end boss 44′ of metal by being interposed between the piston 43 and the bottom-side end boss 44′ and at the same time absorbs shock by means of its elasticity if the piston 43 approaches to the bottom-side end boss 44′.

As described above, cylinder cushion device according to the present invention has the following advantages.

Since the elastic body is interposed between the piston and the end boss, it is possible to prevent the piston from colliding with the end boss and absorb shock by means of its elasticity.

Further, since the cushion sleeve has a smaller length, insertion time of the cushion sleeve to the hole of the end boss is delayed so that the hydraulic oil inside the end boss can smoothly be ejected through the greater clearance. Therefore, the cushion pressure inside the bottom-side chamber B does not excessively increase so that damage of the hydraulic cylinder due to the whole pressure inside the rod-side or bottom-side chamber can be avoided in spite of additional rod pressure due to operation of the excavator.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. In a cylinder cushion device in a hydraulic cylinder for an excavator, the hydraulic cylinder including a tube constituting a receiving chamber of hydraulic oil, a rod performing straight line motion inside the tube depending on inflow and outflow of the hydraulic oil, a piston fixed onto the rod, dividing the receiving chamber of the tube into a rod-side chamber and a bottom-side chamber, and an end boss at one end of the tube, having holes that enable insertion of the rod and outflow of the hydraulic oil, the improvements comprising:
a cushion sleeve provided on the rod to be adjacent to the piston, generating a predetermined cushion pressure inside the rod-side chamber as it is inserted into the hole of the end boss with a predetermined clearance if the piston is adjacent to the end boss during straight line motion of the rod; and
an elastic body provided on the cushion sleeve, preventing the piston from colliding with the end boss and absorbing shock by means of its elasticity.

2. The cylinder cushion device as claimed in claim 1, wherein the cushion sleeve has a length small enough effectively to smoothly eject the hydraulic oil inside the rod-side chamber, thereby preventing the cushion pressure inside the rod-side chamber from excessively increasing.

3. The cylinder cushion device as claimed in claim 1, wherein the cushion sleeve has an outer diameter small enough effectively to smoothly eject the hydraulic oil inside the rod-side chamber, thereby preventing the cushion pressure inside the rod-side chamber from excessively increasing.

4. The cylinder cushion device as claimed in claim 1, wherein the elastic body has an O-ring shape of rubber material with a round shaped cross-section.

5. The cylinder cushion device as claimed in claim 1, wherein the elastic body has an O-ring shape of rubber material with a polygonal cross-section.

6. The cylinder cushion device as claimed in claim 1, wherein the elastic body has a ring shape of composite material with metal plates on opposite sides of a central elastic material.

7. The cylinder cushion device as claimed in claim 2, wherein the cushion sleeve has an outer diameter small enough effectively to smoothly eject the hydraulic oil inside the rod-side chamber, thereby preventing the cushion pressure inside the rod-side chamber from excessively increasing.

8. The cylinder cushion device as claimed in claim 7, wherein the elastic body has an O-ring shape of rubber material with a round shaped cross-section.

9. The cylinder cushion device as claimed in claim 7, wherein the elastic body has an O-ring shape of rubber material with a polygonal cross-section.

10. The cylinder cushion device as claimed in claim 7, wherein the elastic body has a ring shape of composite material with metal plates on opposite sides of a central elastic material.

11. The cylinder cushion device as claimed in claim 8, wherein the elastic body has a ring shape of composite material with metal plates on opposite sides of a central elastic material.

12. The cylinder cushion device as claimed in claim 9, wherein the elastic body has a ring shape of composite material with metal plates on opposite sides of a central elastic material.
